(19) United States
(12) Patent Application Publication
(10) Pub. No.: US 2002/0153990 A1
(43) Pub. Date: Oct. 24, 2002

(54) Switch having a bimetal plate with two legs

(76) Inventor: Tsung-Mou Yu, Taipei (TW)

Correspondence Address: SUPREME PATENT SERVICES, POST OFFICE BOX 2339, SARATOGA, CA, 95070, US

(21) Appl. No.: 09/839,104

(22) Filed: Apr. 19, 2001

(51) Int. Cl. H01H 37/52

(52) U.S. Cl. 337/333

(57) ABSTRACT

A switch device includes a switch case having a passage in a top thereof so as to receive a button therein. A non-conductive plate extends laterally from the button. A first terminal plate and a second terminal plate respectively extending from the casing. A first contact point extends from a side of the second terminal plate. A bimetal plate is connected to the first terminal plate and has two legs extending therefrom. A conductive member is connected between the two legs and connected to the second terminal plate when the button is pushed. The plate is located between the conductive member and the second terminal plate when the button jump up and the two legs are deformed away from the second terminal plate.

### FIELD OF THE INVENTION

The present invention relates to a switch device employing a bimetal plate which has a body and two legs extending from the body. A conduction member is connected between the two legs. The area of the bimetal plate is smaller than the conventional bimetal plate.

### BACKGROUND OF THE INVENTION

A conventional bimetal plate 6′ used in a switch device is shown in FIG. 8b and generally is an elongated metal plate involving two metal material therein. Two ends of the bimetal plate 6′ are pressed to be a recess 61′ and a protrusion portion 62′ is punched in a mediated portion of the bimetal plate 6′. The protrusion portion 62′ makes the mediate portion be higher than the two ends and the two recesses 61′ provide a tension to let the bimetal plate 6′ have a tendency to jump upward when heated. The conventional bimetal plate 6′ has a certain width and size limitation so that the size of the switch receiving the bimetal plate 6′ cannot be reduced. Besides, the cost of the bimetal plate 6′ is high so that the larger area the bimetal plate 6′ is, the higher cost the manufacturers are suffered.

The present invention intends to provide an improved bimetal plate that has a body with two legs and has smaller area than the conventional bimetal plate.

### SUMMARY OF THE INVENTION

In accordance with one aspect of the present invention, there is provided a switch device and comprises a switch case having a passage for receiving a button therein. A non-conductive plate extends laterally from the button and is located in the switch case. A first terminal plate and a second terminal plate respectively extending from an underside of the case. A bimetal plate has a body and two legs extend from the body. The body is connected to the first terminal plate. A conductive member is connected between the two legs and contacts the second terminal plate. The plate is movably located between the conductive member and the second terminal plate.

The primary object of the present invention is to provide a switch device that employs a U-shaped bimetal plate which has smaller area compared with the conventional bimetal plate.

These and further objects, features and advantages of the present invention will become more obvious from the following description when taken in connection with the accompanying drawings which show, for purposes of illustration only, several embodiments in accordance with the present invention.

### BRIEF DESCRIPTION OF THE DRAWINGS

FIG. 1 is a perspective view to show the switch device of the present invention;

FIG. 2 is a perspective view to show a first part of the switch device of the present invention;

FIG. 3 is an exploded view to show the switch device of the present invention;

FIG. 4 is a plan view to show the interior arrangement of the switch device of the present invention wherein the button is pushed;

FIG. 5 is a side elevational view to show the non-conductive plate on the button is removed from the first and the second contact point;

FIG. 6 is a plan view to show the interior arrangement of the switch device of the present invention wherein the button jumps up;

FIG. 7 is a side elevational view to show the non-conductive plate on the button separates the first and the second contact point;

FIG. 8a shows the bimetal plate and the conductive member of the switch device of the present invention;

FIG. 8b shows a conventional bimetal plate;

FIG. 9a shows a unit of bimetal material can produce three bimetal plates of the present invention, and

FIG. 9b shows that the unit of bimetal material can only produce two conventional bimetal plates.

### DETAILED DESCRIPTION OF THE PREFERRED EMBODIMENT

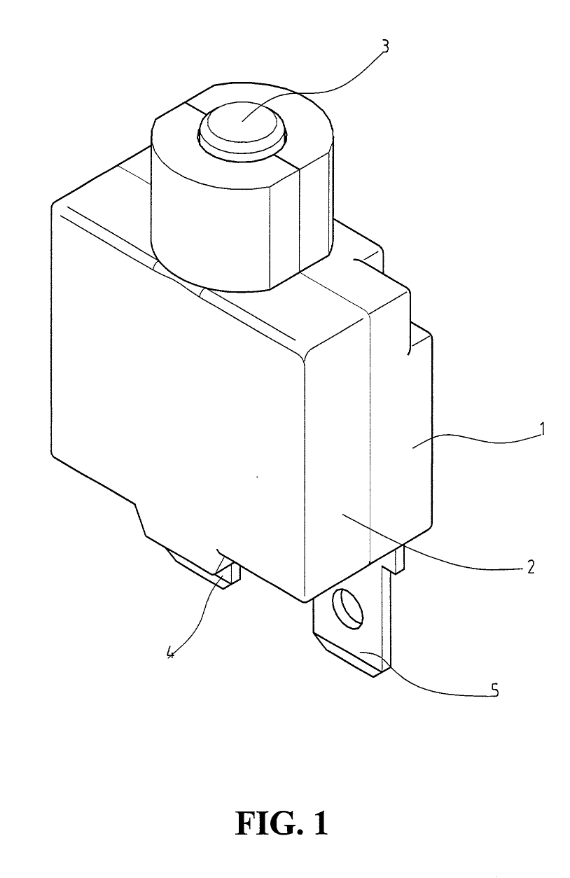

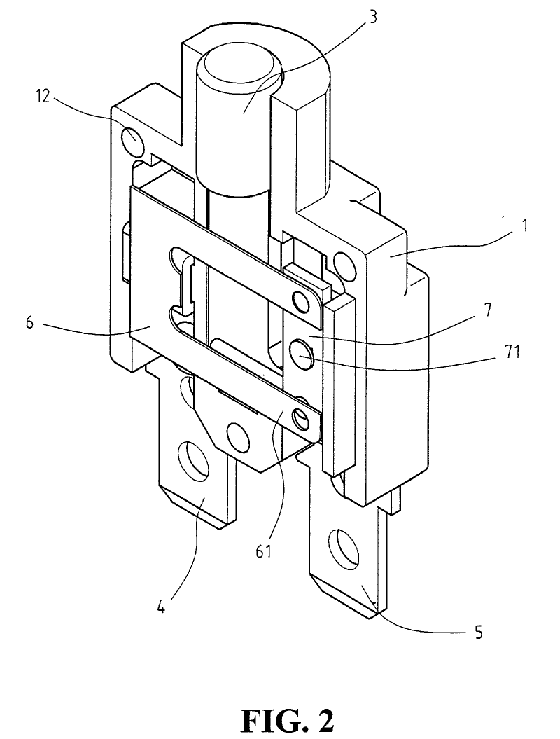

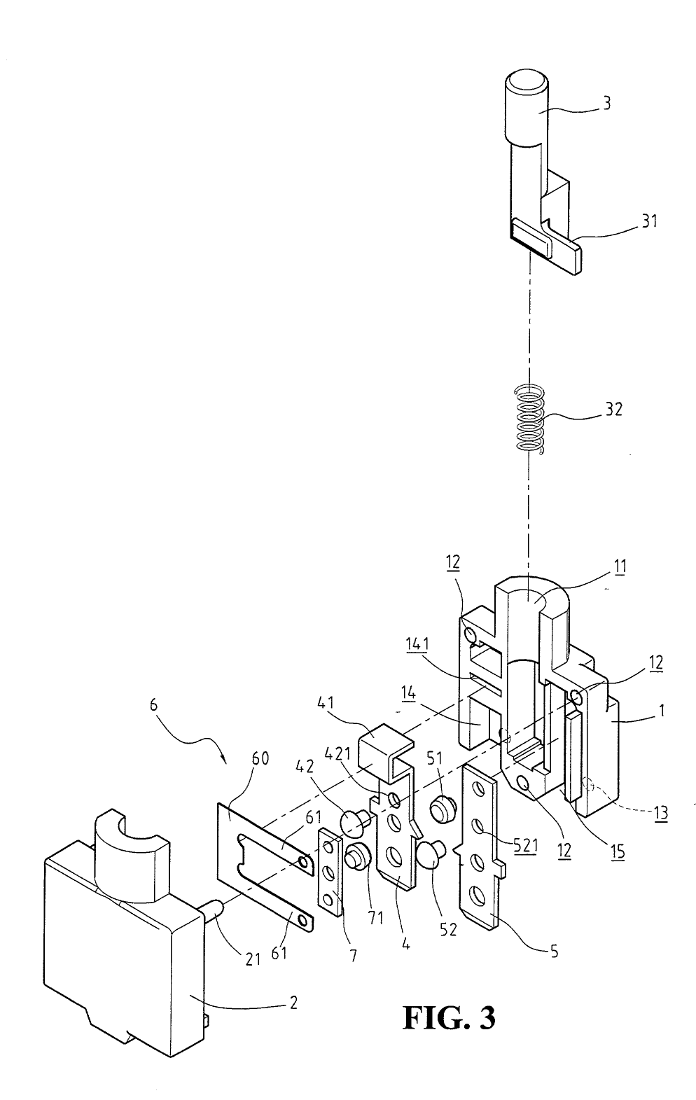

Referring to FIGS. 1 to 3, the switch device of the present invention comprises a switch case composed of a first part 1 and a second part 2. Three recesses 12 are defined in a surface of the first part 1 and three rods 21 (only two are shown) extend from the second part 2, the rods 21 engaged with the recesses 12 to combine the first part 1 and the second part 2. A passage 11 is defined through a top of the case and two slots 14, 15 are respectively defined in an underside of the case. A button 3 is movably received in the passage 11 and a non-conductive plate 31 extends laterally from the button 3 and is located in the switch case. A spring 32 is biased between the button 3 and an inner periphery of the passage 11.

A first terminal plate 4 and a second terminal plate 5 are respectively engaged with the two slots 14, 15. A slit 141 is defined in the first part 1 and the first terminal plate 4 has a hook-like end 41 which is engaged with the slit 141. The first terminal plate 4 and the second terminal plate 5 each have a connection hole 421/521, and the first part 1 has two engaging holes 13, 14 defined therein. Two rivets 42, 52 respectively extend through the connection holes 421, 521 and engaged with the engaging holes 13, 14 to fixedly position the two terminal plates 4, and 5. A first contact point 52 extends from a side of the second terminal plate 5 and a second contact point 71 extends from a side of the conductive member 7.

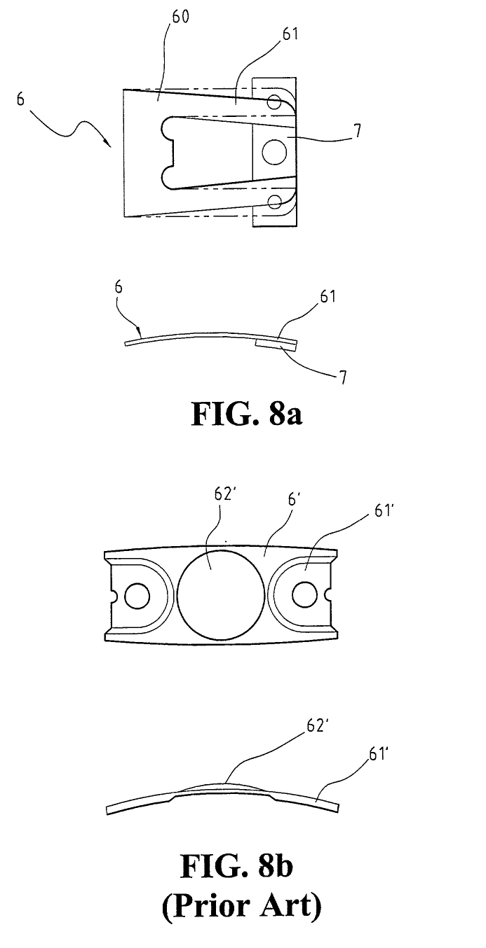

Referring to FIG. 8a, a bimetal plate 6 has a body 60 and two legs 61 extend from the body 60. The body 60 is connected to the first terminal plate 4 and a conductive member 7 is connected between the two legs 61. The non-conductive plate 31 on the button 3 is movably located between the second contact point 71 of the conductive member 7 and the first contact point 52 of the second terminal plate 5.

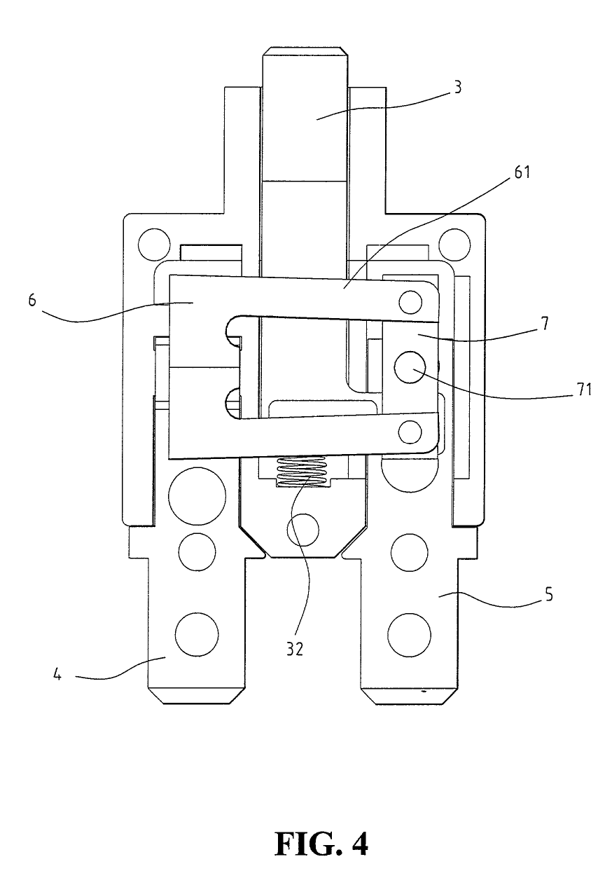

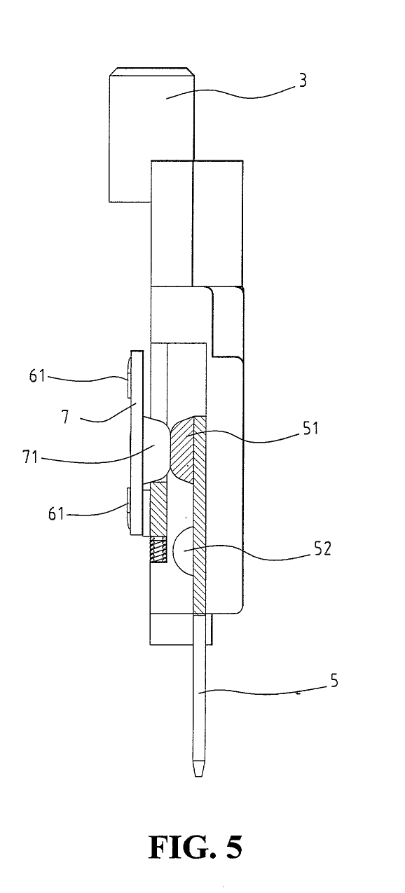

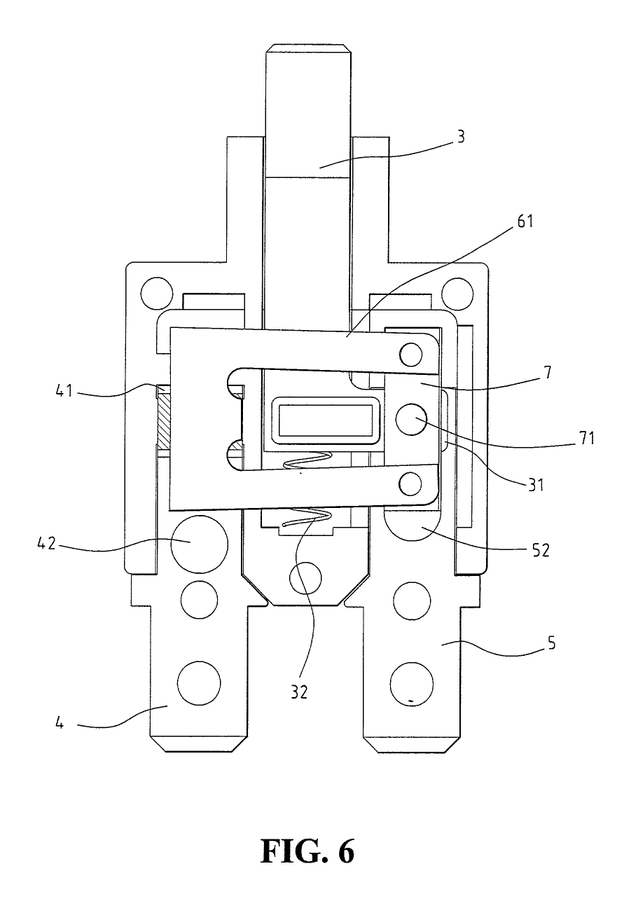

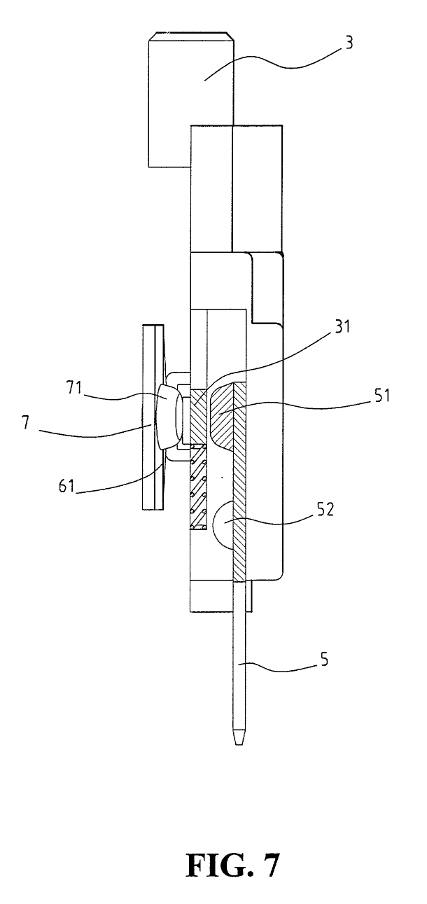

FIGS. 4 and 5 show that when the button 3 is pushed, the spring 32 is compressed and the non-conductive plate 31 is lowered so that the first contact point 52 and the second contact point 71 contacts. The current may pass through the first terminal plate 4, the bimetal plate 6, the second contact point 71, the first contact point 51 and the second terminal plate 5 to form a circuit. FIGS. 6 and 7 show that when the current overrides, the two legs 61 are deformed and move the conductive member 7 away from the second terminal plate 5 and the spring 32 is not stopped by the second contact point 71 so that the spring 32 bounces the button upward. The the non-conductive plate 31 is moved upward to be sandwiched between the first contact point 52 and the second contact point 71 to open the circuit.

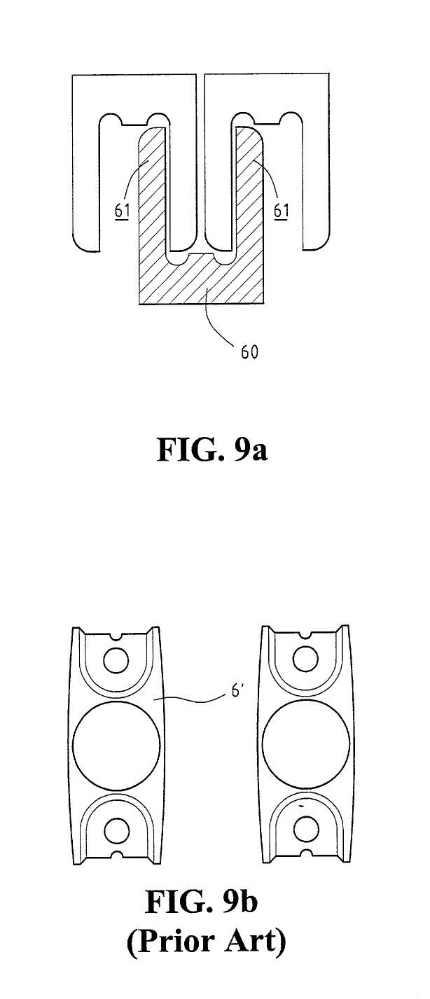

Referring to FIGS. 9a and 9b, a unit of bimetal material can produce three bimetal plates 6 of the present invention. However, the same unit of bimetal material can only produce two conventional bimetal plates 6′. Accordingly, the material of the bimetal plate 6 of the present invention is only ⅔ of the conventional bimetal plate 6′. This allows the size of the switch device to be reduced.

While we have shown and described various embodiments in accordance with the present invention, it should be clear to those skilled in the art that further embodiments may be made without departing from the scope and spirit of the present invention.

What is claimed is:

1. A switch device comprising:
a switch case having a passage defined through a top of said case and two slots respectively defined in an underside of said case, a button movably received in said passage and a non-conductive plate extending laterally from said button and located in said switch case, a first terminal plate and a second terminal plate respectively engaged with said two slots, and
a bimetal plate having a body and two legs extending from said body, said body connected to said first terminal plate, a conductive member connected between said two legs and said nonconductive plate movably located between said conductive member and said second terminal plate.

2. The device as claimed in claim 1 further comprising a first contact point extending from a side of said second terminal plate and a second contact point extending from a side of said conductive member, said non-conductive plate movably located between said first contact point and said second contact point.

3. The device as claimed in claim 1 further comprising a spring biased between said button and an inner periphery of said passage.

4. The device as claimed in claim 1, wherein said case is composed of a first part and a second part a plurality of recesses defined in a surface of said first part and a plurality of rods extending from said second part, said rods engaged with said recesses.

5. The device as claimed in claim 1 further comprising a slit defined in said first part and said first terminal plate has an end which is engaged with said slit.

6. The device as claimed in claim 4 wherein each of said first terminal plate and said second terminal plate has a connection hole, said first part having two engaging holes defined therein, two rivets respectively extending through said connection holes and engaged with said engaging holes.
